(19) United States
(12) Patent Application Publication
(10) Pub. No.: US 2013/0083355 A1
(43) Pub. Date: Apr. 4, 2013

(54) INFORMATION PROCESSING SYSTEM, DATA PROCESSING DEVICE, AND INFORMATION PROCESSING METHOD

(71) Applicant: Hironori TANAKA, Kanagawa (JP)

(72) Inventor: Hironori TANAKA, Kanagawa (JP)

(73) Assignee: FUJI XEROX CO., LTD., Tokyo (JP)

(21) Appl. No.: 13/465,094

(22) Filed: May 7, 2012

(30) Foreign Application Priority Data
Oct. 4, 2011 (JP) 2011-220385

(51) Int. Cl. G06F 3/12; G06K 15/02

(52) U.S. Cl. 358/1.15

(57) ABSTRACT

An information processing system includes a print server that generates print data and a data processing device that processes the print data. The print server transmits the generated print data to the data processing device. The data processing device generates processed data by processing the print data transmitted from the print server. The data processing device transmits the processed data to the print server. The print server transmits the processed data as new print data to a printer.

### CROSS-REFERENCE TO RELATED APPLICATIONS

This application is based on and claims priority under 35 USC 119 from Japanese Patent Application No. 2011-220385 filed Oct. 4, 2011.

### BACKGROUND

### Technical Field

The present invention relates to information processing systems, data processing devices, and information processing methods.

### SUMMARY

According to an aspect of the invention, there is provided an information processing system including a print server that generates print data and a data processing device that processes the print data. The print server transmits the generated print data to the data processing device. The data processing device generates processed data by processing the print data transmitted from the print server. The data processing device transmits the processed data to the print server. The print server transmits the processed data as new print data to a printer.

### BRIEF DESCRIPTION OF THE DRAWINGS

An exemplary embodiment of the present invention will be described in detail based on the following figures, wherein:

FIG. 1 illustrates the configuration of an information processing system according to an exemplary embodiment of the present invention; and

FIG. 2 is a flowchart illustrating the operation of the information processing system according to this exemplary embodiment.

### DETAILED DESCRIPTION

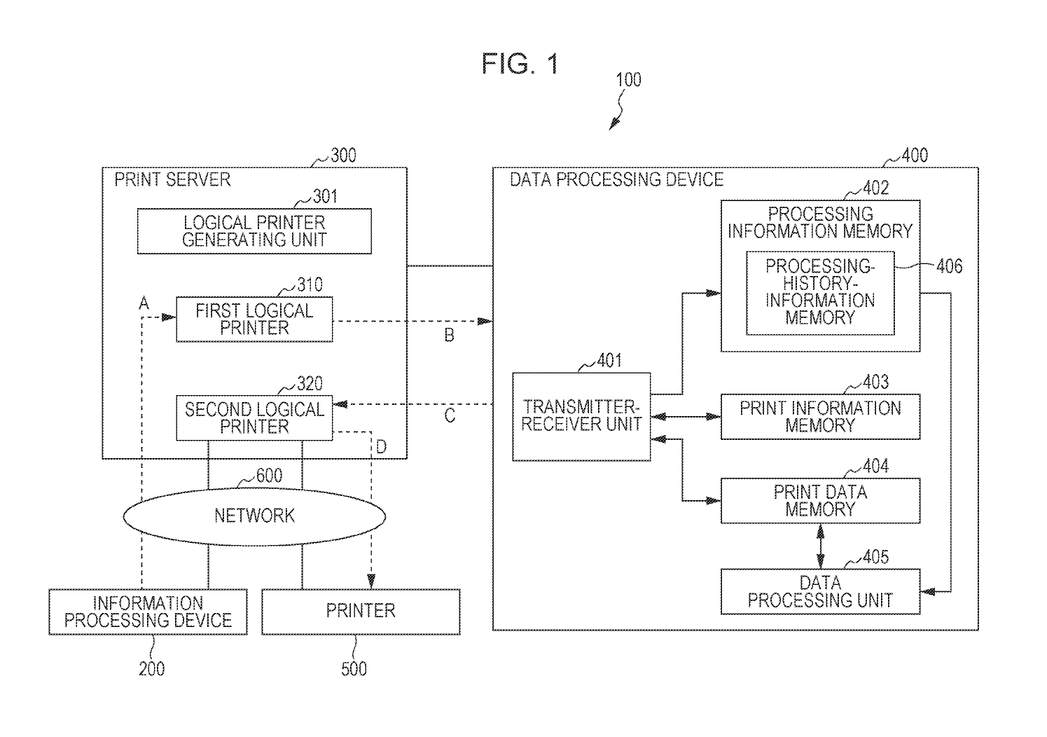

An exemplary embodiment of the present invention will be described below with reference to the drawings. FIG. 1 illustrates the configuration of an information processing system 100 according to an exemplary embodiment of the present invention. The information processing system 100 provides a cloud print service by receiving a print command from a user via the Internet and making a pre-registered printer connected to the Internet perform printing operation.

The information processing system 100 includes an information processing device 200, a print server 300, a data processing device 400, and a printer 500. The print server 300, the information processing device 200, and the printer 500 are connected to each other via a network 600. The information processing device 200, the print server 300, and the data processing device 400 are information processors, such as personal computers, and the printer 500 is a device having a printing function.

The information processing device 200 generates a print command for document data on the basis of user operation, and transmits the generated print command to the print server 300 via the network 600.

Based on the document-data print command transmitted from the information processing device 200 via the network 600, the print server 300 generates print data on the basis of the document data designated in the print command and print settings included in the print command. Moreover, the print server 300 transmits the print data to the printer 500 via the network 600.

The data processing device 400 obtains the print data generated in the print server 300 and processes the print data, and then transmits the processed data together with a print command to the print server 300. A detailed description of the data processing device 400 will be provided later.

The printer 500 receives the print data transmitted from the print server 300 via the network 600 and prints the print data.

The network 600 is a communication network that performs communication via, for example, the Internet. The network 600 has a firewall function that permits communication based on data that satisfies predetermined conditions, so that the information processing device 200 and the printer 500 are protected from communication (access) based on data that does not satisfy the predetermined conditions. The print server 300 has a configuration for performing communication based on data that satisfies the predetermined conditions.

Next, the print server 300 and the data processing device 400 will be described in detail. The print server 300 is connected to multiple information processing devices including the information processing device 200, multiple printers including the printer 500, and multiple data processing devices including the data processing device 400. The print server 300 generates print data based on a print command transmitted from any one of the information processing devices and outputs the print data to at least one of the multiple printers or the multiple data processing devices.

The print command includes information indicating, for example, a user ID of the user transmitting the print command, document data to be printed (i.e., data in a general document data format, storage location information of the document data, or information for identifying the document data), print format information (the number of copies to be printed, the print paper size, color or monochrome printing, etc.), processing designation information, and device information. In this case, the processing designation information is used for designating processing detail information preliminarily set in the data processing device 400 in association with the user ID. The processing detail information indicates the details of processing to be performed on the print data. The details of processing include instructions of, for example, watermark printing, overlaying of a stamp image, and an addition of a serial number. The processing detail information is stored in a processing information memory 402 of the data processing device 400, to be described later. The device information is a device ID for designating a destination device to which the print data generated on the basis of the print command is to be output. In this case, the device information includes a processing device ID for designating the data processing device 400 and a printer ID for designating the printer 500.

The print server 300 is an information processor having a central processing unit (CPU) and a memory (not shown). The print server 300 includes a logical printer generating unit 301, a first logical printer 310, and a second logical printer 320. The logical printer generating unit 301, the first logical printer 310, and the second logical printer 320 are functional blocks that are configured by the CPU executing a program stored in the aforementioned memory. The first logical printer 310 and the second logical printer 320 are virtual printers that are configured (defined) by data (referred to as “logical printer data” hereinafter) that defines logical printers. The first logical printer 310 and the second logical printer 320 are defined so as output print data to the data processing device 400 and the printer 500, respectively.

Based on data transmitted from external devices, such as the data processing device 400 and the printer 500, connected to the print server 300, the logical printer generating unit 301 generates logical printer data that defines logical printers, such as the first logical printer 310 and the second logical printer 320, corresponding to the external devices. When an external device is connected to the print server 300, the logical printer generating unit 301 obtains the device ID of the external device from the external device and generates logical printer data defining a logical printer that is to transmit print data to the external device. The device ID includes address information on the network, which is for specifying the device, and MAC address information for identifying the device. One piece of logical printer data is generated for each external device.

The first logical printer 310 is a logical printer generated in correspondence with the data processing device 400. The first logical printer 310 obtains a print command including device information indicating the device ID of the data processing device 400, which is transmitted from an external device (i.e., the information processing device 200 in this exemplary embodiment), and generates print data based on the print command. The print data generated here is, for example, electronic data in a page description language (PDL) format, a portable document format (PDF) or the like. The first logical printer 310 outputs the generated print data to the data processing device 400 corresponding to the first logical printer 310 together with information included in the print command, such as the user ID, the print format information, the processing designation information, and the device information from which the device ID of the data processing device 400 has been deleted. When the aforementioned print command is processed, only the device ID of the printer 500 is included in the device information.

The second logical printer 320 is a logical printer generated in correspondence with the printer 500. The second logical printer 320 obtains a print command including the device information indicating the device ID of the printer 500, which is transmitted from an external device (i.e., the data processing device 400 in this exemplary embodiment), and outputs the print data included in the print command to the printer 500 together with the print format information and the device information received from the data processing device 400 from which the device ID of the printer 500 has been deleted. When the aforementioned print command is processed, the device information does not include device IDs.

The data processing device 400 is an information processor including a CPU and a memory (not shown). The data processing device 400 includes a transmitter-receiver unit 401, a processing information memory 402, a print information memory 403, a print data memory 404, and a data processing unit 405. The transmitter-receiver unit 401 and the data processing unit 405 are functional blocks that are configured by the CPU executing a program stored in the memory. The processing information memory 402, the print information memory 403, and the print data memory 404 serve as a part of the aforementioned memory.

The transmitter-receiver unit 401 performs communication with the print server 300. The transmitter-receiver unit 401 receives a signal transmitted from the print server 300, outputs the signal to the processing information memory 402, the print information memory 403, and the print data memory 404, and transmits data input from the print information memory 403 and the print data memory 404 to the print server 300. The transmitter-receiver unit 401 operates as a unit that transmits processed data to the print server 300.

The processing information memory 402 stores the user ID and the processing detail information, which are received from the information processing device 200 via the print server 300, in association with each other.

The processing information memory 402 includes a processing-history-information memory 406. The processing-history-information memory 406 stores a history of processing performed in the data processing device 400 (i.e., the data processing unit 405). The data processing device 400 performs processing on the basis of the processing history information stored in the processing-history-information memory 406. For example, in a case where a serial-number adding process is performed in the data processing device 400, the most recently added serial number is stored, and in a subsequent serial-number adding process, the data processing device 400 adds a numerical value of 1 to the serial number stored in the processing-history-information memory 406.

The print information memory 403 temporarily stores the user ID, the print format information, and the device information included in the print command received from the print server 300.

The print data memory 404 stores the print data included in the print command received from the print server 300 and the processed data generated by the data processing unit 405.

The data processing unit 405 processes the print data received from the print server 300 and stored in the print data memory 404 on the basis of the processing detail information that is stored in the processing information memory 402 in association with the user ID included in the print command and that is designated by the processing designation information included in the print command, and outputs the processed data to the print data memory 404. The processed data output to and stored in the print data memory 404 is included in a print command to be transmitted to the print server 300 by the transmitter-receiver unit 401 and is transmitted thereto as new print data together with the user ID, the print format information, and the device information (included in the print command) stored in the print information memory 403.

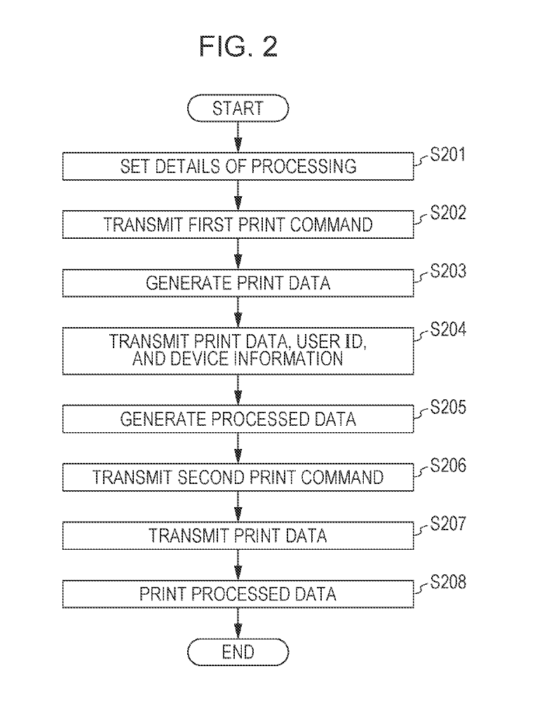

Next, the operation of the information processing system 100 according to this exemplary embodiment will be described below with reference to a flowchart. FIG. 2 is a flowchart illustrating the operation of the information processing system 100 according to this exemplary embodiment.

In step S201, prior to a printing process, the information processing device 200 transmits information for setting the details of processing to be performed on print data on the basis of user operation to the data processing device 400 together with a user ID. The processing information memory 402 of the data processing device 400 stores the aforementioned information and the user ID so that the processing details are set.

In step S202, the information processing device 200 transmits a first print command including the user ID, document-data identification information, print format information, and processing designation information to the print server 300. The flow of data in step S202 is indicated by an arrow A in FIG. 1.

In step S203, the first logical printer 310 of the print server 300 obtains document data on the basis of the document-data identification information that is set in association with the processing designation information included in the first print command and that is included in the first print command transmitted in step S202, and generates print data from the document data on the basis of the print format information included in the first print command.

In step S204, the first logical printer 310 of the print server 300 transmits the print data generated in step S203, the user ID included in the first print command, and the device ID of the printer 500, which indicates a device to which the print data is to be output, to an external device (i.e., the data processing device 400) designated by the device ID defined as output destination information in the first logical printer 310. The flow of data in step S204 is indicated by an arrow B in FIG. 1.

In step S205, the data processing unit 405 of the data processing device 400 processes the print data transmitted in step S204 so as to generate processed data.

In step S206, the data processing device 400 transmits a second print command including the processed data generated in step S205 as print data to the print server 300. The second print command includes the user ID included in the first print command and is used for requesting printing to the print server 300 based on the device ID of the printer 500 included in the first print command as output destination information. As described above, the device information indicates the device to which the print data is to be output. The flow of data in step S206 is indicated by an arrow C in FIG. 1.

In step S207, the print server 300 selects the second logical printer 320 that corresponds to the aforementioned device ID of the printer 500 included in the first print command, which is the output destination information included in the received print command. The second logical printer 320 generates print data on the basis of the processed data and the second print command transmitted from the data processing device 400 in step S206 and transmits the generated print data to an external device (i.e., the printer 500) designated by the device ID (i.e., printer ID) defined in the second logical printer 320. The flow of data in step S207 is denoted by an arrow D in FIG. 1.

In step S208, the printer 500 receives the print data (i.e., the processed data) transmitted in step S207 and performs printing operation. Accordingly, the process in the information processing system 100 ends.

According to the above-described configuration, the information processing system 100 performs printing of the processed data obtained by processing the print data generated in the print server 300.

In an environment in which the printer 500 is capable of performing printing of the print data generated in the print server 300 connected thereto via the network 600, even when the data processing device 400 transmits a print command to the printer 500 via the network 600, the intervention of a firewall may make it impossible to perform printing. Even in that case, with the above-described configuration, the data processing device 400 may transmit a print command including processed data obtained as a result of processing performed therein to the print server 300 as print data, so that the print server 300 may cause the printer 500 to perform the printing process.

In the above exemplary embodiment, although the information processing device 200 is configured to transmit a print command including information indicating a user ID, document data, print format information, processing designation information, and device information indicating a device to which print data is to be output, the exemplary embodiment of the present invention is not limited to this configuration. The print command to be transmitted from the information processing device 200 may be configured to not include some information in the aforementioned information. For example, the device information may be configured to not include a printer ID. In this case, the printer ID may be determined by the data processing device 400 on the basis of contents set in advance. Furthermore, multiple logical printers may be preliminarily set in correspondence with multiple kinds of processing to be performed by a single data processing device 400. In this case, the print command may be configured to not include a processing device ID in the device information, but may alternatively include information designating a logical printer that corresponds to the appropriate processing.

Furthermore, the print server 300 may include a logical-printer access controller that controls access to the first logical printer 310 and the second logical printer 320. In this case, for example, a system administrator may set the logical-printer access controller so as to control whether the logical printers are allowed or not allowed to be used by multiple users (or multiple information processing devices).

The above-described operation of the print server 300 is achieved by operating the program stored in the memory (not shown) in the print server 300. Furthermore, the above-described operation of the data processing device 400 is achieved by operating the program stored in the memory (not shown) in the data processing device 400. These programs may be provided via communication, or may be loaded from a computer-readable storage medium, such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a print server that generates print data; and
a data processing device that processes the print data,
wherein the print server transmits the generated print data to the data processing device,
wherein the data processing device generates processed data by processing the print data transmitted from the print server,
wherein the data processing device transmits the processed data to the print server, and
wherein the print server transmits the processed data as new print data to a printer.

2. The information processing system according to claim 1, wherein the print server includes a logical-printer-data generating unit that generates logical printer data defining a logical printer corresponding to an external device connected to the print server on the basis of a signal transmitted from the external device, and
wherein, based on a signal transmitted from the data processing device, the logical-printer-data generating unit generates logical printer data defining a logical printer that corresponds to the data processing device and that transmits the print data to the data processing device.

3. The information processing system according to claim 1, wherein the print server transmits the print data to the printer via a network that permits communication based on data that satisfies a predetermined condition.

4. The information processing system according to claim 2, wherein the print server transmits the print data to the printer via a network that permits communication based on data that satisfies a predetermined condition.

5. The information processing system according to claim 1, wherein the data processing device includes a processing-history-information memory that stores processing history information based on processing performed on the print data, and performs processing on the basis of the processing history information.

6. The information processing system according to claim 2, wherein the data processing device includes a processing-history-information memory that stores processing history information based on processing performed on the print data, and performs processing on the basis of the processing history information.

7. The information processing system according to claim 3, wherein the data processing device includes a processing-history-information memory that stores processing history information based on processing performed on the print data, and performs processing on the basis of the processing history information.

8. The information processing system according to claim 4, wherein the data processing device includes a processing-history-information memory that stores processing history information based on processing performed on the print data, and performs processing on the basis of the processing history information.

9. A data processing device that generates processed data by processing print data transmitted from a print server by which the print data is generated, the data processing device comprising:
a unit that transmits the processed data to the print server.

10. An information processing method in an information processing system including a print server that generates print data and a data processing device that processes the print data, the method comprising:
transmitting the generated print data from the print server to the data processing device;
generating processed data by causing the data processing device to process the print data transmitted from the print server;
transmitting the processed data from the data processing device to the print server; and
transmitting the processed data as new print data from the print server to a printer.
